(19) United States
(12) Patent Application Publication
(10) Pub. No.: US 2026/0252796 A1
(43) Pub. Date: Aug. 27, 2026

(54) INFORMATION PROCESSING APPARATUS, INFORMATION PROCESSING METHOD, AND NON-TRANSITORY COMPUTER-READABLE STORAGE MEDIUM STORING A PROGRAM

(71) Applicant: KABUSHIKI KAISHA TOSHIBA, Kawasaki-shi (JP)

(72) Inventors: Tomohiro YAMASAKI, Bunkyo Tokyo (JP); Hiroko FUJII, Komae Tokyo (JP)

(73) Assignee: KABUSHIKI KAISHA TOSHIBA, Kawasaki-shi (JP)

(21) Appl. No.: 19/443,539

(22) Filed: Jan. 8, 2026

(30) Foreign Application Priority Data
Feb. 21, 2025 (JP) 2025-026671

(51) Int. Cl. G06F 40/279; G06F 16/353

(52) U.S. Cl. CPC G06F 40/279; G06F 16/353

(57) ABSTRACT

According to one embodiment, an information processing apparatus includes a first selection unit that selects at least one of a plurality of pieces of text data, a second selection unit that selects related text data that is other text data related to the selected text data, a classification unit that classifies the selected text data and the related text data into text for each topic, an extraction unit that extracts feature representations corresponding to predetermined feature representation labels from the text data classified for each topic, a specification unit that specifies the feature representations for each feature representation label, a display control unit that causes a display unit to display the feature representations with different appearances for each feature representation label, and a storage unit that stores the text data, the feature representations, and the feature representation labels.

### CROSS-REFERENCE TO RELATED APPLICATION(S)

This application is based upon and claims the benefit of priority from Japanese Patent Application No. 2025- 026671, filed February 21, 2025, the entire contents of which are incorporated herein by reference.

### FIELD

Embodiments described herein relate generally to an information processing apparatus, method, and a non-transitory computer-readable storage medium storing a program for processing text data related to communication.

### BACKGROUND

In recent years, electronic mail, chat, messages, and the like are generally used as communication tools. For example, important information is buried in text data in a communication tool, but there are many pieces of text data that are not recorded documents, and it is expected that the efficiency of business is improved by effectively utilizing these pieces of information. However, if text data that is not organized as a recorded document is set as a search target and related text data is simply connected and displayed at the time of display, it is difficult to understand the correspondence relationship between the text data and the related text data related thereto.

### BRIEF DESCRIPTION OF THE DRAWINGS

FIG. 1 is a schematic diagram illustrating a configuration of an information processing apparatus according to a first embodiment.

FIG. 2 is a functional configuration diagram of the information processing apparatus according to the first embodiment.

FIG. 3 is a diagram illustrating the relationship between the text data of the reply source and the text data of the reply.

FIG. 4 is a schematic diagram illustrating the structure of the extraction unit 103 of the information processing apparatus according to the first embodiment.

FIG. 5 is a diagram illustrating a configuration of feature representation information according to the first embodiment.

FIG. 6 is a flowchart illustrating an information processing method using the information processing apparatus according to the first embodiment.

FIG. 7 is a diagram illustrating an example of the structure of metadata related to the text data according to the first embodiment.

FIG. 8 is an example of a display method of the information processing apparatus according to the first embodiment.

FIG. 9 is a diagram illustrating a generation example of a second display method of the information processing method using the information processing apparatus according to the first embodiment.

FIG. 10 is a diagram illustrating a first display method and a second display method of the information processing method using the information processing apparatus according to the first embodiment.

FIG. 11A and 11B are flowcharts of creation of a second display method of the information processing method using the information processing apparatus according to the first embodiment.

FIG. 12 is a functional configuration diagram of an information processing apparatus according to a second embodiment.

FIG. 13 is a flowchart illustrating an information processing method using the information processing apparatus according to the second embodiment.

### DETAILED DESCRIPTION

In general, according to an aspect of the invention,

there is provided an information processing apparatus that includes a first selection unit that selects at least one of a plurality of pieces of text data, a second selection unit that selects related text data that is other text data related to the selected text data, a classification unit that classifies the selected text data and the related text data into text for each topic, an extraction unit that extracts a feature representation corresponding to a predetermined feature representation label from the text data classified for each topic, a specification unit that specifies the feature representation for each feature representation label, a display control unit that causes a display unit to display the feature representation with an appearance different for each feature representation label, and a storage unit that stores the text data, the feature representation, and the feature representation label.

### First Embodiment

Hereinafter, embodiments of the present invention will be described. In the specification and the drawings, the same reference numerals are given to the same elements as those described above, and detailed description thereof will be appropriately omitted.

In the present embodiment, a document (text data) to which information is added over time is targeted. For example, a case where text data is visualized separately for each topic from mails in a reply relationship exchanged until a trouble is solved will be described, but chat exchange may be performed instead of mail, and a log of telephone responses may be used when a problem is solved while inquiring of a call center. Here, the mail in the reply relationship refers to a mail formed between a sender and a recipient in mail exchange. Alternatively, a document in which a sentence is newly added to an original document, such as a daily work report or a transfer book, may be targeted. For example, text data may include exchanges from conversations involving multiple people. However, the embodiment relating to the trouble that has occurred in the business is an example, and the present embodiment is applicable to a case relating to other text data. Each feature representation is assigned a feature representation label (for example, "phenomenon", "cause", "countermeasure", and "result of countermeasure").

As a method of extracting feature representations from text data, a named entity extraction method as described in Non-Patent Document 1 (Sheng Zhang, Hao Cheng, Jianfeng Gao, Hoifung Poon, Optimizing Bi-Encoder for Named Entity Recognition via Contrastive Learning, ICLR2023, 23rd Feb. 2023) may be used. In the present embodiment, it is possible to extract a feature representation corresponding to a feature representation label by referring to text data. The feature representation refers to text corresponding to a feature representation label, which is extracted from text data by using a feature representation extraction model learned from learning data that exemplifies a set of a feature representation label and a feature representation. For example, in the case of text data related to a trouble, the feature representation labels "phenomenon", "cause", " countermeasure ", and "result of countermeasure" are set. A feature representation corresponding to a predetermined feature representation label is learned as learning data, the feature representation is extracted from text data, and the feature representation label corresponding to the feature representation is specified. For example, as the feature representation related to the feature representation label of "phenomenon", there are "increase in processing time", "error occurrence", and the like. The operator can add or delete the feature representation label as appropriate.

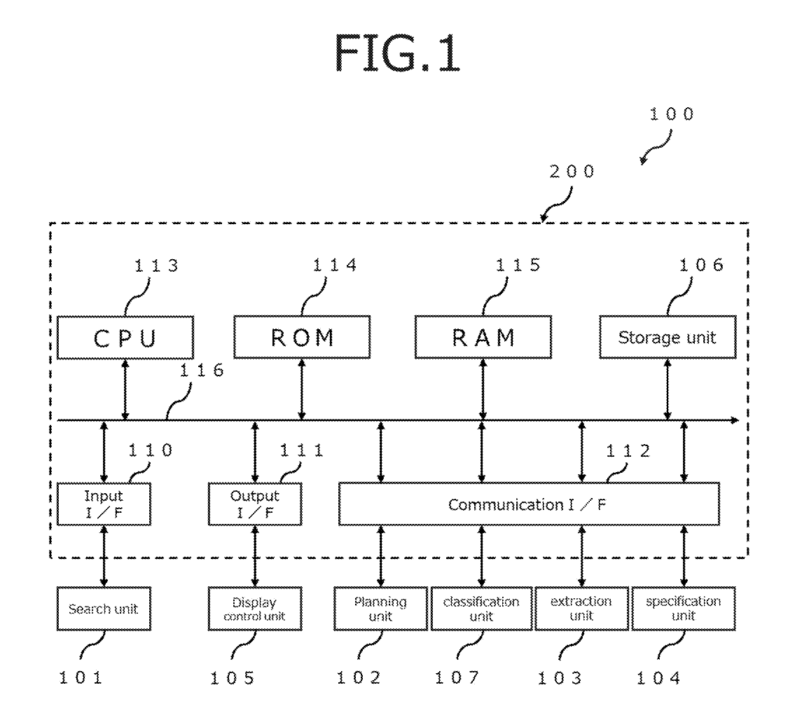

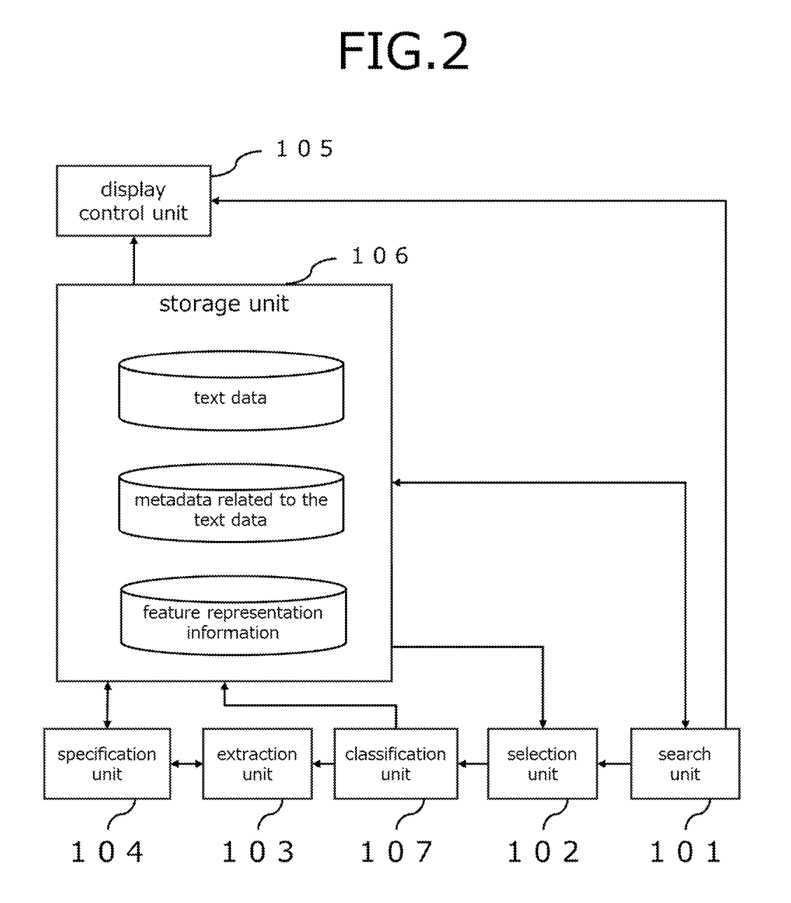

FIG. 1 is a schematic diagram illustrating a configuration of an information processing apparatus according to a first embodiment. FIG. 2 is a functional configuration diagram of the information processing apparatus according to the first embodiment. As illustrated in FIG. 1, an information processing apparatus 100 according to the first embodiment includes a search unit 101, a selection unit 102, an extraction unit 103, a specification unit 104, a display control unit 105, a classification unit 107, and a processing device 200. The processing device 200 includes a storage unit 106, an input interface (I/F) 110, an output interface (I/F) 111, a communication interface (I/F) 112, and CPU 113, ROM 114, RAM 115, and system buses 116.

The search unit 101 receives a search condition related to a feature representation label of text data input by a user. The text data is, for example, data related to a conversation in an electronic mail. Here, the user inputs a search condition related to the feature representation label, and thus it is possible to search for text data corresponding to the search condition input by the user from the past text data. The search unit 101 sends the search result of the text data related to the search condition to the selection unit 102.

The feature representation label may be set in advance, and examples thereof include "phenomenon", "cause", "countermeasure", "result of countermeasure", "possibility", "individual opinion", and "inference". The user inputs a search condition related to the feature representation label of "phenomenon", and a feature representation corresponding to the feature representation label of "phenomenon" of past text data is set as a search target. The user may input a search condition related to the feature representation label of "countermeasure", and the feature representation corresponding to the feature representation label of "countermeasure" of the past text data may be set as a search target. Alternatively, both "phenomenon" and "countermeasure" may be search targets by using an AND search. The user selects text data related to a problem that has occurred in business from the search result by a selection unit 102 with reference to the storage unit 106. The display control unit 105 will be described later.

The selection unit 102 refers to the storage unit 106, acquires at least one piece of text data from among a plurality of pieces of text data (search results), and further acquires text data related to a problem that has occurred in business.

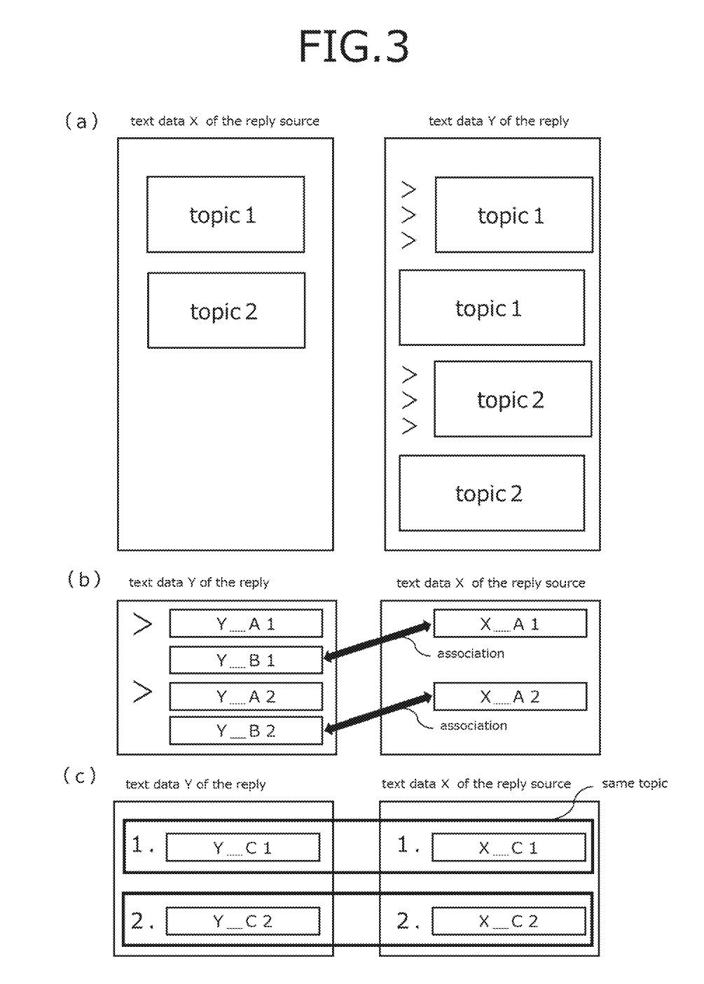

FIG. 3 is a diagram illustrating a relationship between the text data of the reply source and the text data of the reply. The classification unit 107 divides the text included in the series of text data acquired by the selection unit 102 into topics, and organizes the divided text for each topic.

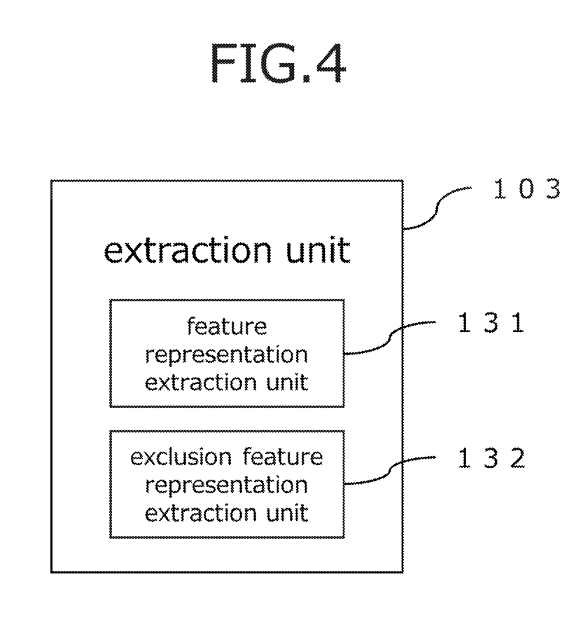

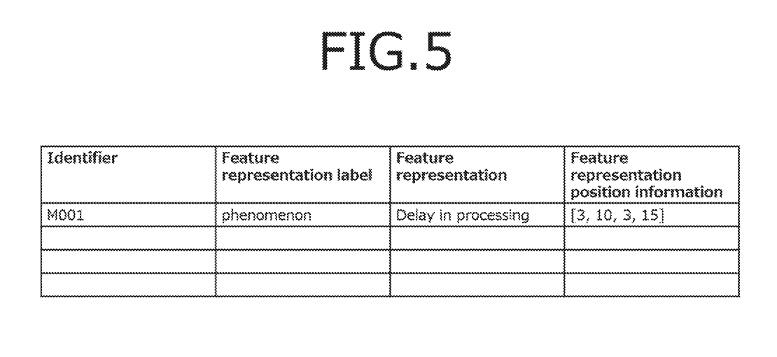

FIG. 4 is a schematic diagram illustrating a structure of the extraction unit 103 of the information processing apparatus according to the first embodiment. The extraction unit 103 includes a feature representation extraction unit 131 and an exclusion feature representation extraction unit 132. The feature representation extraction unit 131 extracts feature representation information from the text data selected by the selection unit 102 and the related text data in the storage unit 106. FIG. 5 is a diagram illustrating a configuration of feature representation information according to the first embodiment. The feature representation information includes an identifier, a feature representation, a feature representation label corresponding to the feature representation, and feature representation position information. The identifiers are codes (for example, M001) assigned to identify the respective text data. The feature representation position information is composed of [line number including tag range start character, position of tag range start character in line, line number including tag range end character, position of tag range end character in line + 1]. By extracting the feature representation position information, it is possible to specify a portion in the text data where the feature representation is displayed.

The exclusion feature representation extraction unit 132 extracts the excluded feature representation from the text data, and does not display (excludes) the exclusion feature representation on a display unit (not illustrated). The exclusion feature representation is a feature representation corresponding to a predetermined feature representation label to be excluded, and refers to a feature representation to be excluded from the text data. The feature representation labels to be excluded (exclusion labels) include, for example, "possibility", "individual opinion", "inference", and the like. Further, as a feature representation related to the feature representation label of "possibility", there is "there is a possibility of an abnormality in software" or the like. At this time, "there is a possibility of an abnormality in software" corresponds to the exclusion label of "possibility", and thus is extracted as an exclusion feature representation, but is excluded from the final display of the display unit.

Further, instead of defining labels such as "possibility", "individual opinion", and "inference" as feature representation labels, these feature representations may be excluded using predetermined clue expressions to be excluded. The clue expression refers to a text string including an expression related to a possibility, a personal opinion, and an inference, such as "I think …”,” there is a possibility of …” and the like in the text data, and is an expression to be excluded from the final display is manually set. First, as exclusion labels, "possibility", "individual opinion", "inference", and the like are not set, and only feature representation labels to be displayed of "phenomenon", "cause", "countermeasure", and "result of countermeasure" are set. A sentence including a feature representation to which the set feature representation label is assigned may be extracted, and a sentence corresponding to the clue expression to be excluded may be excluded. For example, in the case of a sentence "there is a possibility of an abnormality in the software", when only "phenomenon", "cause", "countermeasure", and "result of countermeasure" are set as feature representation labels, "abnormality in the software" is extracted as a feature representation corresponding to the "phenomenon" label. When "there is a possibility" is set as the clue expression, a sentence including the extracted feature representation, "there is a possibility of an abnormality in the software", matches this pattern. Therefore, the feature representation "abnormality in the software" corresponds to the feature representation label of "phenomenon", but since there is the clue expression "there is a possibility", the feature representation or the feature representation label is not extracted, and is excluded from the final display of the display unit.

The identification unit 104 extracts feature representations in one text data selected by the user and the related text data by the extraction unit 103, and identifies a feature representation label corresponding to the extracted feature representations. For example, the feature representation related to the feature representation label of "phenomenon" is displayed with a solid line frame and a bold characters, the feature representation related to the feature representation label of "cause" is displayed with a dotted line frame, the feature representation related to the feature representation label of "countermeasure" is displayed with a solid line frame and an italic characters, and the feature representation related to the feature representation label of "result of countermeasure" is displayed with a dashed-dotted line frame. The display method does not necessarily follow the above described method, and the feature representation labels may have different appearances, for example, may be distinguished by colors. The identifying unit 104 refers to the metadata of the text data in the storage unit 106, determines whether the text data selected by the selecting unit 102 includes the Reply-To information, and associates the text data with the related text data according to the citation relationship using the Reply-To information. The metadata related to the text data includes at least an identifier, header information of the electronic mail, and information of a mail body (for example, a body portion of the electronic mail) in the case of text data related to an electronic mail, for example.

The ROM 114 stores a program necessary for causing the computer to implement the above-described processes.

The RAM 115 functions as a storage area in which the program stored in the ROM 114 is loaded.

The CPU 113 includes processing circuitry. The CPU 113 executes a program stored in at least one of the RAM 115 and the storage unit 106 using the RAM 115 as a work memory. During execution of the program, the CPU 113 controls each component via the system bus 116 and executes various processes.

The storage unit 106 stores data necessary for executing the program and data obtained by executing the program. The storage unit 106 also stores the text data selected by the selection unit 102. The storage unit 106 stores text data, metadata related to the text data, and feature representation information. The storage unit 106 includes, for example, one or more selected from a hard disk drive (HDD) and a solid state drive (SSD). The feature representation information is information of a feature representation extracted from the body of text data, and refers to an identifier of the text data from which the feature representation is extracted, a feature representation label corresponding to the feature representation, the feature representation, and feature representation position information.

The storage unit 106 stores a specific connection among the feature representations extracted by the extraction unit 103. Specifically, when a "phenomenon" occurs, the "causes" that caused the "phenomenon" are arranged in order. For example, the arrangement of "phenomenon" and "cause" is collected as one "phenomenon/cause". Further, "countermeasure" is collected as one "countermeasure", and "result" is collected as one "result". Then, the connection of the "countermeasure" to the "phenomenon/cause" and the connection of the "result" to the "countermeasure" are stored in chronological order. In general, there are zero or more "countermeasure" for the "phenomenon/cause", and there is zero or one "result" for the "countermeasure", and thus the entire connection of the time series has a tree structure.

The input interface (I/F) 110 connects the processing device 200 and the search unit 101. The input I/F 110 includes, for example, one or more selected from a mouse, a keyboard, a microphone (audio input), and a touch pad. The CPU 113 can read various types of information from the search unit 101 via the input I/F 110.

The output interface (I/F) 111 connects the processing device 200 and the display control unit 105. The output interface I/F 111 is a video output interface such as a digital visual interface (DVI) or a high definition multimedia interface (HDMI). The CPU 113 sends the display control 105 via output I/F 111.

The communication interface (I/F) 112 connects the selection unit 102, the extraction unit 103, the specification unit 104, and the information processing apparatus 100 outside the processing apparatus 200. The communication I/F 112 is, for example, a network card such as a LAN card. The CPU 113 can read various types of information from the selection unit 102, the extraction unit 103, and the specification unit 104 via the communication I/F 112.

The display control unit 105 displays the search result (text data) acquired by accessing the storage unit 106 on the display unit in a different appearance based on the search condition received by the search unit 101. The display unit displays the related text data by the first display method or the second display method using the information of the specifying unit 104 and the storage unit 106.

The first display method is a method of displaying each topic group classified by the classification unit 107 in the order of appearance. Whether it's a series of multiple emails or a specific email selected by the user, sections corresponding to different topics are displayed with different background colors.

The second display method is a method of displaying the connections of the feature representations stored in the storage unit 106 in the order of appearance for each topic group classified by the classification unit 107. As described above, the entire connection of feature representations has a tree structure, and thus the feature representations may be directly displayed in the tree structure. Alternatively, a table may be displayed so that it is understood that a plurality of "countermeasures" correspond to one "phenomenon/cause". Since the tree structure has an inclusion relationship, it may be displayed in a Venn diagram. At this time, as in the first display method, different background colors or patterns are given to portions corresponding to different topics, and the topics are displayed so as to be distinguished from each other. Alternatively, the user may be allowed to select a specific topic, and only the portion corresponding to the topic may be displayed.

The display control unit 105 outputs the data received from the output interface 111. The display unit is connected to the display control unit 105, and the display unit is configured by any one of a monitor, a printer, and a projector, for example. In a case where the information processing apparatus according to the present embodiment has a touch panel, it is conceivable that the touch panel has both functions of the search unit 101 and the display unit. In the above embodiment, the display control unit 105 may be mounted on a cloud or the like, and the above display may be performed on a display unit of a local device of the user.

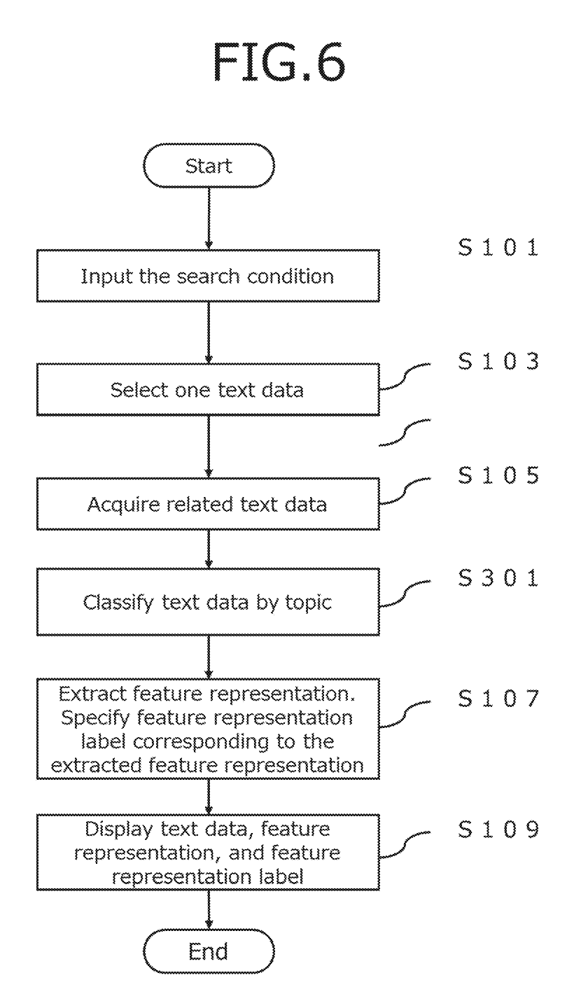

FIG. 6 is a flowchart illustrating an information processing method using the information processing apparatus according to the first embodiment.

### Step S101

The search unit 101 receives a search condition related to the content of text data input by the user. The search condition input at this time is the content related to the feature representation label of the text data, and for example, the search condition associated with the feature representation labels "phenomenon", "cause", "countermeasure", and "result of countermeasure" can be input.

### Step S103

The selection unit 102 refers to the storage unit 106 and acquires text data related to a problem that has occurred in a business operation and that is selected by the user from the search result.

### Step S105

The extraction unit 103 extracts feature representation information from the text data selected by the selection unit 102 and the related text data in the storage unit 106. The extraction unit 103 accesses the storage unit 106 to acquire feature representation information corresponding to the metadata related to the acquired text data.

The extraction unit 103 also traces the citation relationship from the metadata related to the acquired text data, and acquires a plurality of pieces of related text data related to the one piece of text data selected by the user. Tracing the citation relationship refers to tracing which text data is replied to by referring to Reply-To or the like included in the header information. The header information refers to information other than the data text of the text data, that is, the attribute of the text data, and refers to, for example, Message-ID, Reply-To, Date, From, To, and Subject of the electronic mail. The header information also includes an identifier.

The related text data includes all header information about the text data. The entire header information refers to header information of all the text data that can be acquired by tracing the citation relationship.

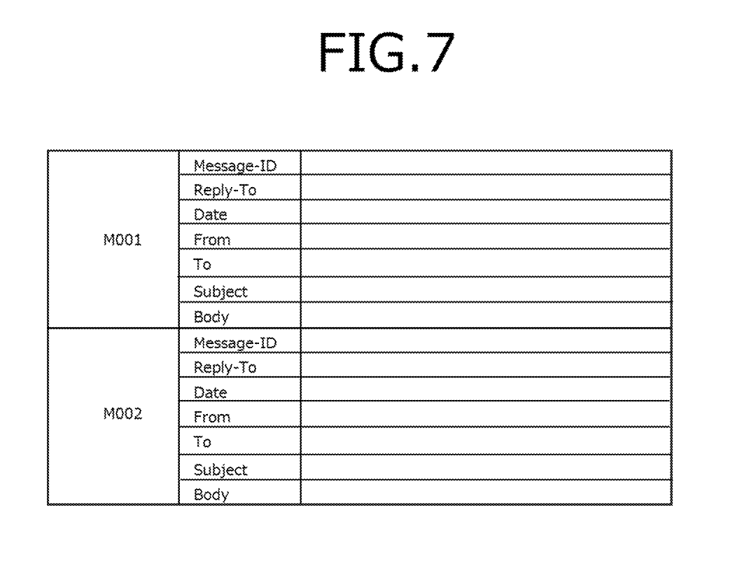

FIG. 7 is a diagram illustrating a configuration example of metadata related to text data according to the first embodiment. The mail body stores a mail body (only a newly added portion) acquired by identifying a reply source mail using the information of Reply-To and performing processing of taking a difference from the original mail in advance.

In FIG. 7, M001 and M002 indicate identifiers, and header information and mail text are displayed on the right side. Further, information of Message-ID may be used as the identifier. Body indicates the mail body, and the others indicate header information. The extraction unit 103 acquires a plurality of pieces of related text data of the text data selected by the selection unit 102, by tracing back the citation relationship of the text data or following emails in which the device itself is the source of the reply. The citation relationship of the text data is acquired by checking the information of Reply-To included in the header information.

### Step S301

The classification unit 107 divides the text included in the series of text data acquired by the data acquisition unit into topics, and collects the divided text for each topic. The text of the text data collected for each topic is stored in the storage unit 106 as classified text data. As a method of dividing the text data for each topic, a plurality of methods described later are conceivable.

The first method is a method of dividing text included in a large-scale document such as Wikipedia into words using a morphological analyzer, learning a distribution of words that are likely to appear in a specific topic in advance, and dividing the text based on a change in the distribution of the words in the text included in a series of text data. Known techniques such as topic models and text tiling can be used. Alternatively, a simple method may be used in which, when a combination of specific words appears, the combination is assigned to a specific topic.

The second method is a method of dividing text using a quotation marker such as ">" and itemization markers such as "·" and "1." as clues. As shown in FIG. 3(a), when there are a plurality of portions to which the quotation marker or the itemized marker is attached in the text data Y of the reply, it is considered that the reply is performed to a plurality of portions of the text data X of the reply source. Therefore, the portions to which the quotation markers are attached (Y_A1, Y_A2, ...) and the portions to which the quotation markers are not attached (Y_B1, Y_B2, ...) in the text data Y are specified, and in the text data X, portions X_A1, X_A2, ... corresponding to Y_A1, Y_A2, ... are associated with Y_B1, Y_B2, ... respectively as pairs belonging to the same topic, such as X_A1 and Y_B1, X_A2 and Y_B2, and so forth. Similarly, as shown in FIG. 3(c), when a plurality of itemized markers are attached to the text data Y and the text data X of the reply source, it is considered that the text data Y and the text data X correspond to each other. Therefore, the itemized marker points X_C1, X_C2, ... of the text data X of the reply source and the itemized marker points Y_C1, Y_C2, ... of the text data Y are specified, and X_C1 and Y_C1, X_C2 and Y_C2, ..., are associated as pairs belonging to the same topic.

The third method is a method of dividing a text using information such as surface-level similarities in a phenomenon name, a device name, and a component name, or as well as using information of a constituent element as a clue. The surface-level similarity of the phenomenon name, the device name, and the component name, or the constituent elements may be set by the user in advance, or may be given in advance by some method. For example, a text data Y may include "The cause of water leakage was loosening of the bolt. The valve was replaced with another one.” The text data X of the reply source includes "Water leaked from the pipe. The check valve rusted.” In this case, the following case is considered. In this case, since "water leakage" and "Water leaked" are similar in terms of both character strings and semantics, X_D1 "Water leaked from the pipe.” and Y_D1 "The cause of water leakage was loosening of the bolt.” can be grouped as a single topics. Furthermore, since "check valve" and "valve" are similar to each other in terms of character strings and meanings, the text X_D2 "The check valve rusted.” and Y_D2 "The valve was replaced with another one.” can be grouped as a single topics. These are examples using clues that are similar in terms of both character strings and meanings, but if it is known that there is a bolt as a constituent element of a pipe, "pipe" in the text data X and "bolt" in the text data Y of the reply source are used as clues and X_D1 “Water leaked from the pipe.” and Y_D1 “The cause of water leakage was loosening of the bolt.” can be grouped as a single topics.

The fourth method is a method of extracting feature representations from past cases accumulated so far, learning a model for determining the presence or absence of a relationship between the feature representations in advance, and collecting connections determined to have a relationship between the feature representations extracted from the text to perform division. For example, it is considered that the only effective countermeasure when an error occurs in the device A is to reset or replace the device A, and the only effective countermeasure when an error occurs in the device B is to replace the device B. The text data X of the reply source includes a message "The device A has caused an error. The device B has caused an error.” and the text data Y only includes "The device was reset and replaced.” In this case, even if the topic of the device A or the topic of the device B is not clearly indicated in the text data Y, only the device A is to be reset, and therefore, the X_E1 "The device A has caused an error.” and Y_E1 " The device was reset.” can be grouped as a single topics. The remaining "replaced” in the text data Y may be "The apparatus A was reset, but the trouble was not solved, so the device A was replaced.” or may be "The device B was replaced", then it is difficult to put the topics together as one topic. In such a case, an approach of collecting topics as much as possible may be used, or a method of dividing topics as finely as possible may be used. In the former case, the Y_E2 "replaced” is also included in X_E1 "The device A has caused an error.” In the latter case, the X_E2 "The device B has caused an error.” and Y_E1 "The device was reset.” are grouped as a single topics.

Although four methods of dividing topics have been described above, a topic divided by a certain method may be further divided by another method, or topics divided by a certain method may be collected by another method, and these methods may be used in combination.

### Step S107

An extraction part 103 extracts feature representations in one text data selected by a user and related text data, and a specification unit 104 specifies feature representation labels corresponding to the extracted feature representations. In the present embodiment, in addition to the feature representation labels "phenomenon", "cause", "countermeasure", and "result of countermeasure" to be extracted, the feature representation labels "possibility", "individual opinion", and "inference" to be excluded can also be defined. By using the learning data, feature representations corresponding to these seven types of feature representation labels can be extracted from the text data as feature representation labels. The extraction unit extracts only feature representations corresponding to one or more feature representation labels of "phenomenon", "cause", "countermeasure", and "result of countermeasure", thereby extracting feature representations not including feature representation labels of "possibility", "individual opinion", and "inference".

The types of feature representation labels may be four types of "phenomenon", "cause", "countermeasure", and "result of countermeasure", and after feature representations corresponding to these types are extracted, the features representation may be excluded from the feature representations by referring to predetermined exclusion features representation. The exclusion feature representation refers to a feature representation (text) that is manually set and is to be excluded from the text data without referring to a predetermined feature representation label that has been learned. When the feature representation does not correspond to the exclusion feature representation, the feature representation related to the text data is extracted as a feature representation label. For example, consider a case where a message "There is a possibility that no improvement is applied to ZZ software.” leads to the extraction of “no improvement is applied to ZZ software" as a "cause" from the description. At this time, the extraction unit 103 acquires a sentence including a feature representation "no improvement is applied to ZZ software", and determines whether the feature representation matches an exclusion feature representation. When the feature representation label exclusion condition includes "There is a possibility", a sentence including the extracted feature representation "There is a possibility that no improvement is applied to ZZ software.”, matches the exclusion feature representation. Therefore, "no improvement applied to ZZ software" is excluded from the feature representation.

### Step S109

The display control unit 105 causes the display unit to display one piece of text data selected by the user among the text data acquired by accessing the storage unit 106, the related text data, and the feature representation by a first display method, or causes the display unit to display the feature representation labels arranged in a tree shape by a second display method, based on the search condition received by the search unit 101, and the first display method and the second display method cause the display unit to display the feature representation to be displayed with different appearances for each feature representation label.

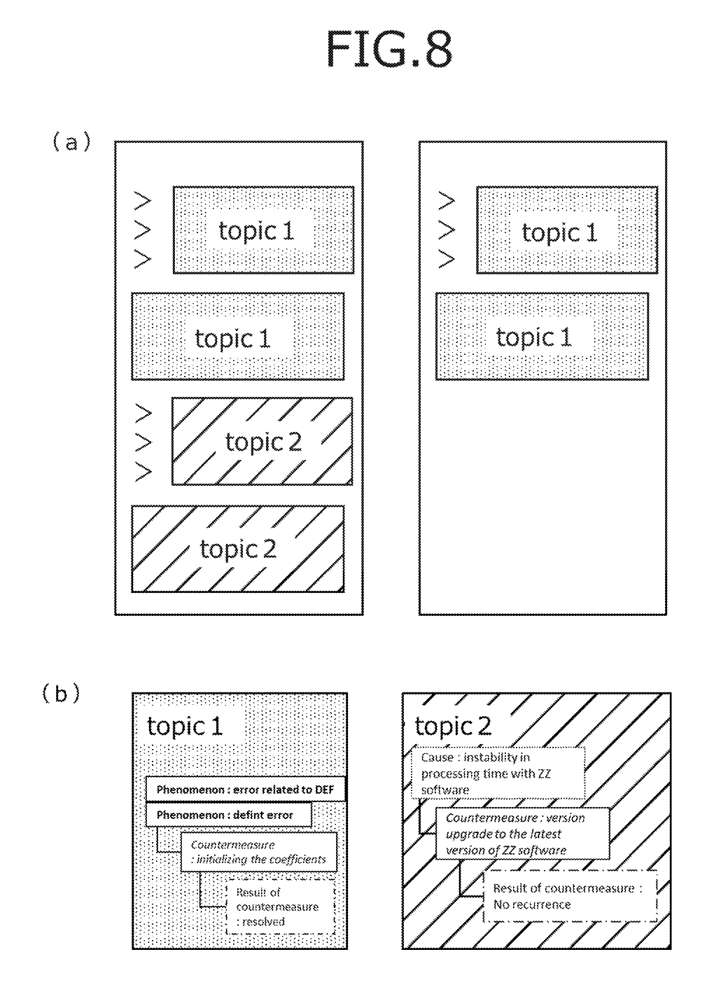

FIG. 8 illustrates a display method of the information processing apparatus according to the first embodiment. FIG. 8(a) illustrates a first display method. The first display method is a method of displaying the topic groups classified by the classification unit 107. As shown in the left diagram of FIG. 8(a), different background colors or patterns are given to the portions corresponding to different topics in both a series of a plurality of mails and a specific mail selected by the user. Alternatively, as shown in the right diagram of FIG. 8(a), the user may be allowed to select a specific topic, and only the portion corresponding to the topic may be displayed.

FIG. 8(b) illustrates a second display method. The second display method is a method of displaying the connection of the feature representations stored in the storage unit 106 for each topic group classified by the classification unit 107. When displaying the feature representation, the feature representation labels are displayed in different appearances so that "phenomenon", "cause", "countermeasure", and "result of countermeasure" can be distinguished. The user can switch between the first display method and the second display method. For example, the display of each related text data may be switched by a tab.

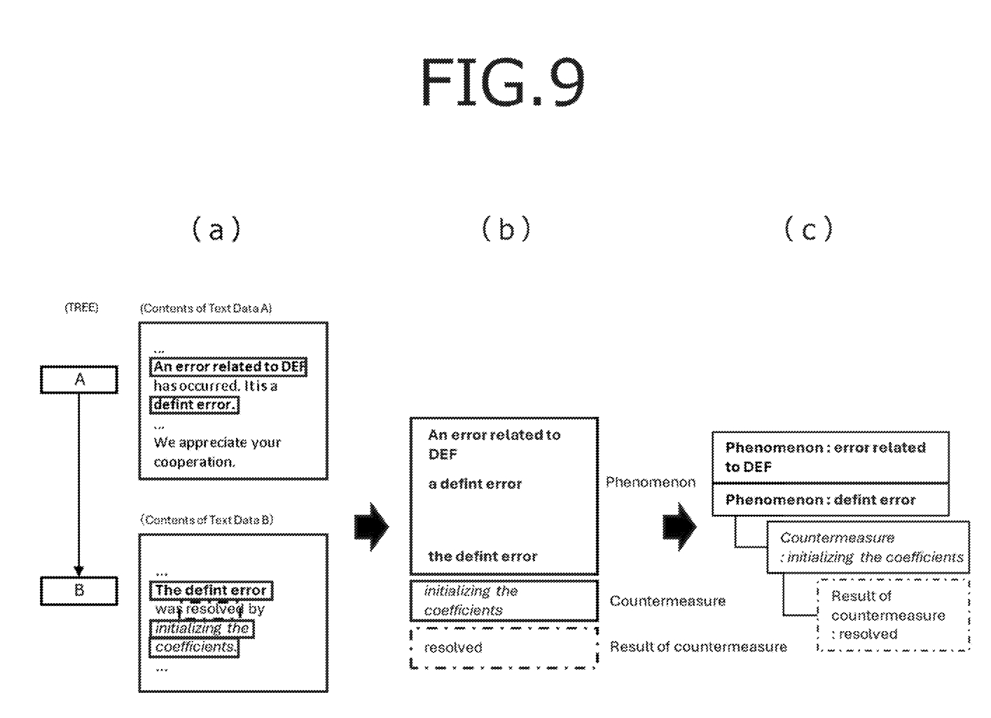

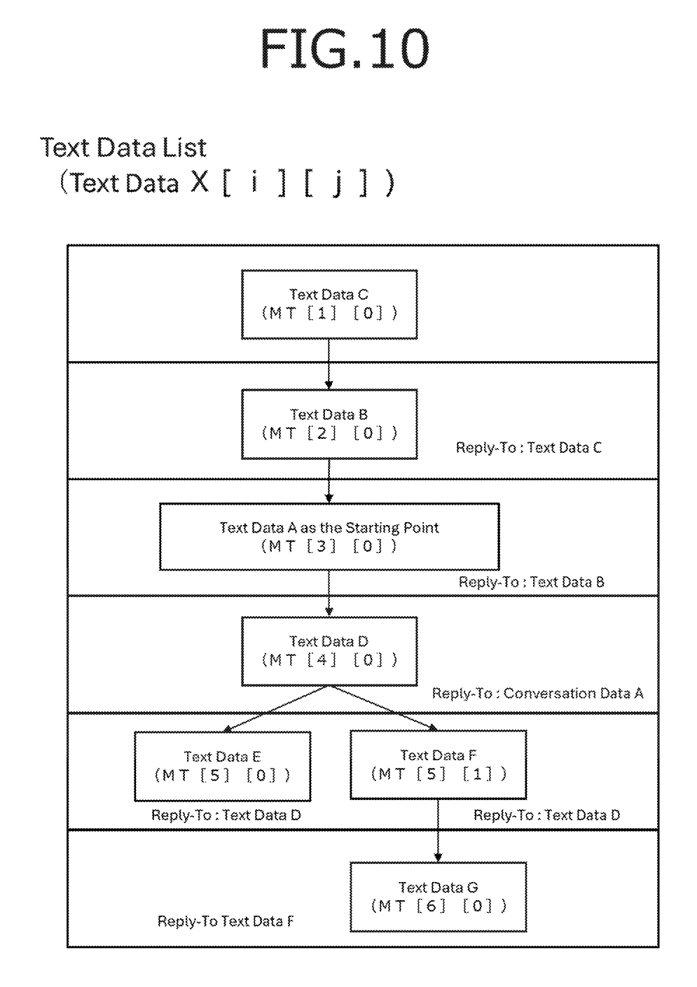

FIG. 9 is a diagram illustrating a generation example of a second display method of the information processing method using the information processing apparatus according to the first embodiment. FIG. 9 a shows an example in which the tree is text data A → text data B. First, the text data extracted by the extraction unit 103 is arranged in a tree shape from the top in the order of appearance and is regarded as one document. Then, as illustrated in FIG. 9(b), the feature representations and the feature representation labels extracted by the specification unit 104 are extracted in the order of appearance, and the same consecutive feature representation labels are collected. For example, in FIG. 9(b), the feature representations of "DEF related error" and "defint error" are collected in the feature representation label of "phenomenon". When a plurality of the same texts appear in the same feature representation label, duplication is removed. For example, in FIG. 9(b), since the feature representation of "defint error" is duplicated in the label of "phenomenon", the duplication is removed. Then, as shown in FIG. 9(c), a portion where the "phenomenon" and "countermeasure" labels are continuous or a portion where the "phenomenon", "countermeasure", and "result of countermeasure" labels are continuous is extracted from these feature representation labels and displayed. When the tree is branched, the tree may be divided into a plurality of partial trees without branches, and then a text data structure may be generated and displayed for each partial tree. For example, in the case of the tree shown in FIG. 10, the tree is divided into two partial trees of C → B → A → D → E and C → B → A → D → F → G, and the structure of the metadata related to the text data shown in FIG. 9(c) is generated.

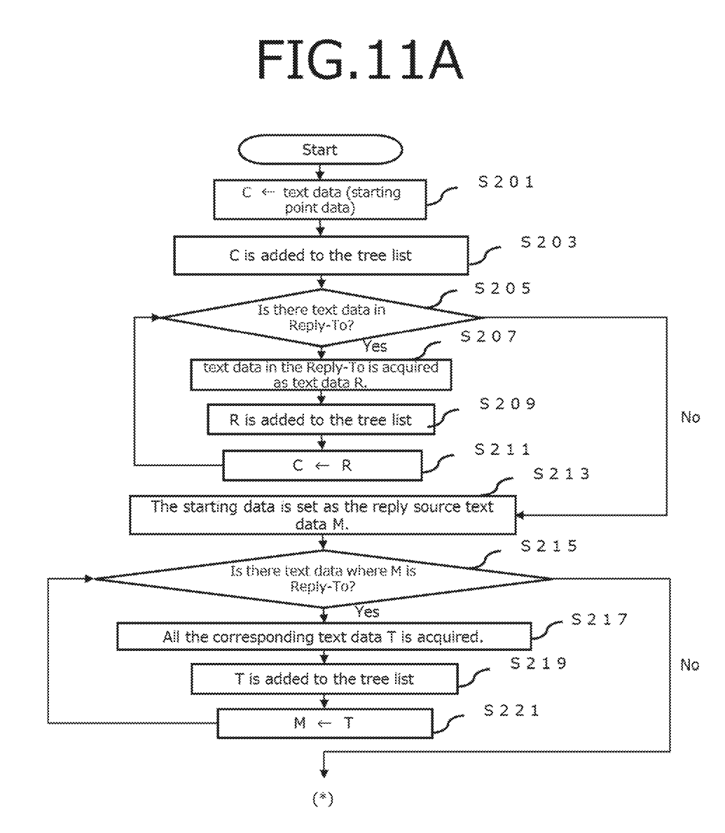

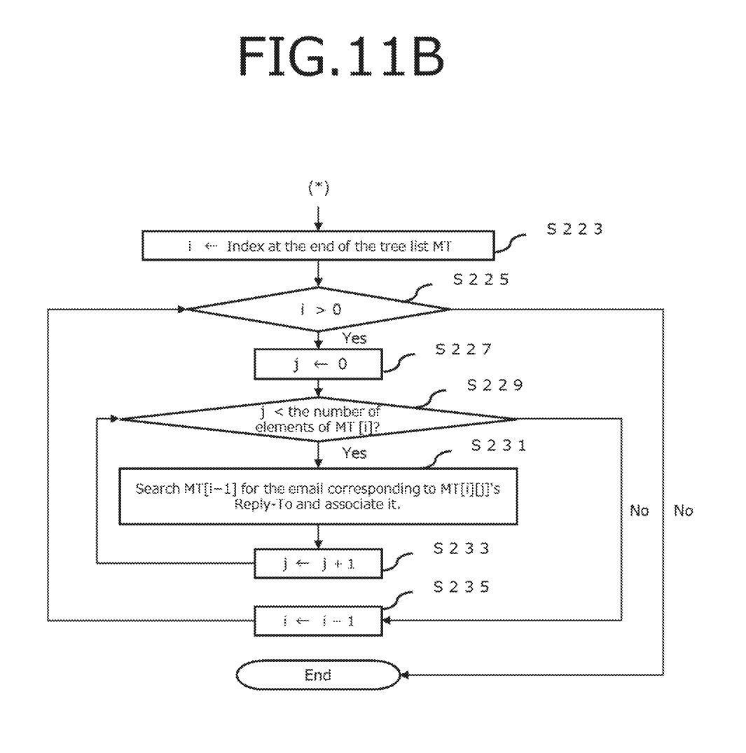

FIG. 11A and 11B are diagrams illustrating a flowchart of creation of a second display method of the information processing method using the information processing apparatus according to the first embodiment.

### Step S201

The text data (starting point data) selected by the user in the selection unit 102 is denoted by C.

### Step S203

The text data C is added to the tree list. The tree list refers to a list of text data according to the first and second display methods to be created.

### Step S205

The specification unit 104 refers to the metadata related to the text data in the storage unit 106 and determines whether or not the Reply-To of the text data C includes an identifier of another text data. When another text data is included in the Reply-To of the text data C, it is understood that the text data C is a reply of the other text data. The body of the text data may not be included in the Reply-To as long as the text data can be specified, and the body of the text data may be included, for example.

### Step S207

If it is determined in step S205 that the Reply-To of the text data C includes another text data, another piece of text data described in the Reply-To is acquired as text data R.

### Step S209

The text data R is added to the head of the tree list.

### Step S211

The text data R is newly set as text data C, and the process returns to step S205.

### Step S213

If the Reply-To of the text data C does not include another piece of text data at step S205, the starting data is set as the reply source text data M.

### Step S215

It is determined whether or not there is text data in which the text data described in the Reply-To information is the reply source text data M. In a case where there is no text data in which the text data described in the Reply-To is the reply source text data M in step S215, the process proceeds to the process of step S223 and the subsequent processes.

### Step S217

In step S215, when there is text data in which the text data described in the Reply-To is the reply source text data M, all the corresponding text data T is acquired.

### Step S219

All the corresponding text data T are added to the end of the tree list.

### Step S221

All the corresponding text data T are set as new reply source text data M, and the process returns to step S215.

### Step S223

In step S223 and subsequent steps, each text data in the tree list is ordered according to the citation relationship. First, the tree list is denoted by MT, and the index at the end of MT is denoted by i. The index at the end of the MT indicates “the number of hierarchies of text data included in the tree list-1”. The index i is an integer of 0 or more. For example, in the case of the tree list of FIG. 10, the number of hierarchies of the text data is 6, and therefore, the index i of the MT is 5.

### Step S225

A determination is made whether the index i of the MT is greater than 0. When i is 0 (“No” in step S225), the condition of i > 0 is not satisfied, then the process ends.

### Step S227

When i is 1 or more (“Yes” in step S225), each piece of text data in MT [i] is associated with the text data that is the reply source in the processing in step S227 and subsequent steps. First, the index j of the element in MT [i] is set to 0.

### Step S229

It is determined whether j is less than the number of elements of MT [i].

### STEP S231

When j is smaller than the number of elements of MT [i] (“Yes” in step S229), the text data which is the j-th reply source in MT [i] is searched from the text data of MT [i- 1] and associated. For example, when the reply source of the text data G (MT [6] [0]) in FIG. 10 is searched, MT [5] is the target.

### Step S233

Thereafter, j is incremented by 1, the text data which is the reply source of the text data of MT [i] is searched, and the process returns to step S229.

### Step S235

When j reaches the number of elements of MT [i] (“No” in step S229), i is decremented by 1, and the process returns to step S225. For example, in the case of FIG. 10, i is 5, and thus steps S225 to S235 are repeated until i becomes 0.

### Second Embodiment

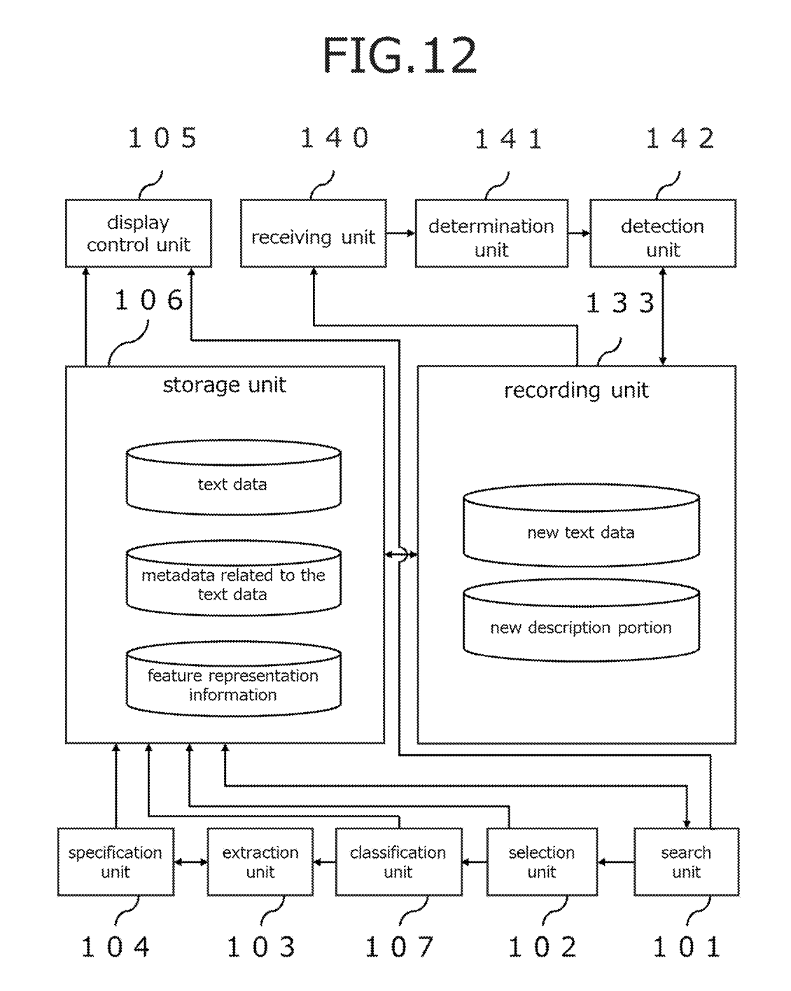

FIG. 12 is a functional configuration diagram of an information processing apparatus according to a second embodiment. The second embodiment is different from the first embodiment in that the second embodiment includes a receiving unit 140, a determination unit 141, a detection unit 142, and a recording unit 133 in addition to the functional configuration of the first embodiment.

The receiving unit 140 receives new text data from the recording unit 133. The reception of the conversation in the recording unit 133 may be performed by manually newly recording a set of text data, or by transferring new text data to the recording unit 133 when an external communication tool receives the new text data.

The determination unit 141 determines whether or not there is a new description portion based on the difference between the new text data and the related text data. The new description portion refers to a portion newly described in new text data.

The detection unit 142 detects a feature representation and a feature representation label corresponding to the feature representation from the new description portion of the determination unit 141.

The recording unit 133 generates feature representation information including the new text data and the new description portion. In addition, the new text data is added to the text data in the storage unit 106, and the metadata related to the text data related to the new text data is added to the metadata related to the text data in the storage unit 106. The feature representation information related to the new text data is added to the feature representation information in the storage unit 106.

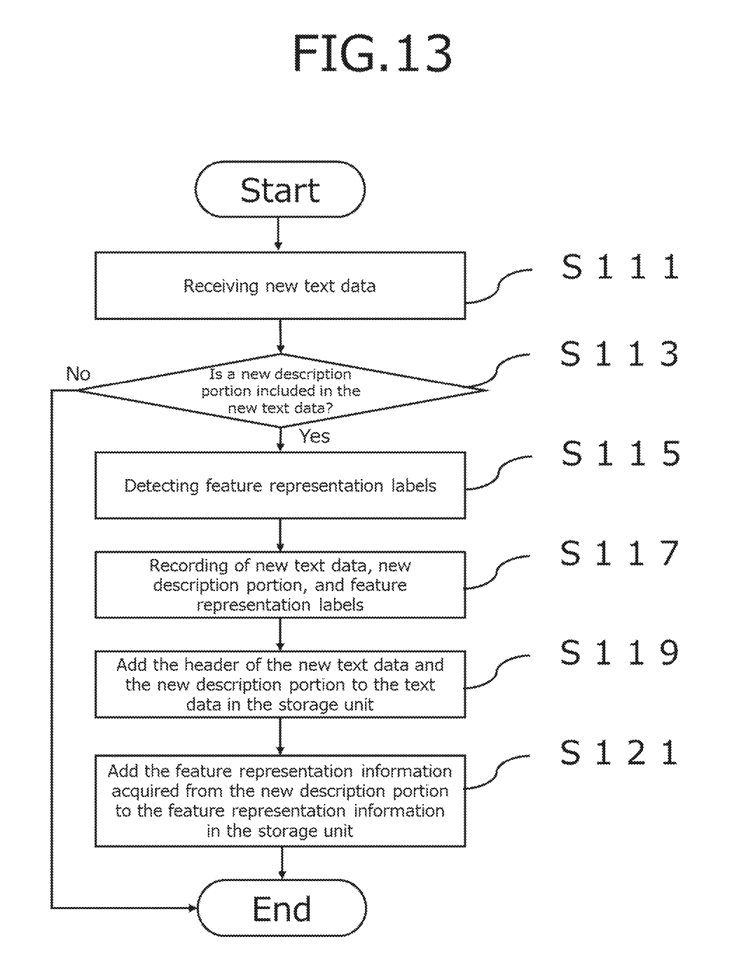

FIG. 13 is a flowchart illustrating an information processing method using the information processing apparatus according to the second embodiment. The second embodiment is different from the first embodiment in that steps S111 to S121 and S301 are added after step S109.

### Step S111

A receiving unit 140 receives new text data.

### Step S113

The determination unit 141 determines whether or not a new description portion is included in the new text data received by the receiving unit 140.

### Step S115

When a new description portion is included in the new text data received by the receiving unit 130 (“YES” in step S113), the detecting unit 142 detects a feature representation of the new description portion and generates feature representation information.

### Step S117

The recording unit 133 creates text data by combining the header of the new text data and the new description portion, and adds the text data to the metadata related to the text data. When the new description portion is not included in the new text data received by the receiving unit 130 (“NO” in step S113), the process is terminated.

### Step S119

The recording unit 133 refers to the storage unit 106 and adds a header and a new description portion of new text data to the text data.

### Step S212

The recording unit 133 refers to the storage unit 106 and the detection unit 142, adds the feature representation information acquired from the new description portion to the feature representation information, and the process is terminated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are included in the invention described in the claims and the equivalent scope thereof.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The disclosure includes a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

What is claimed is:

1. An information processing apparatus that processes text data, the apparatus comprising:
a first selection unit configured to select at least one of the plurality of pieces of text data,
a second selection unit configured to select related text data that is other text data related to the selected text data selected by the first selection unit,
a classification unit configured to classify the selected text data and the related text data into texts for each topic,
an extraction unit configured to extract a feature representation corresponding to a predetermined feature representation label from the text data classified for each topic,
a specifying unit configured to specify the feature representation for each feature representation label,
a display control unit configured to cause a display unit to display the feature representation with an appearance different for each feature representation label,
a storage unit configured to store the text data, the feature representation, and the feature representation label.

2. The information processing apparatus according to claim 1, further comprising
a search unit configured to receive an input related to the feature representation label of the text data.

3. The information processing apparatus according to claim 1, wherein
the text data is related to a document to which information is added over time and is related to text.

4. The information processing apparatus according to claim 1, wherein
the classification unit is configured to
learn a predetermined word that appears in the text data classified into the topic and
classify the text data or the related text data for each topic based on the word in the text data or the related text data.

5. The information processing apparatus according to claim 1, wherein
the classification unit is configured to
classify the text data or the related text data into the topics based on a citation marker.

6. The information processing apparatus according to claim 1, wherein
the extraction unit is configured to
extract a feature representation related to the related text data selected by the second selection unit,
refer to a predetermined excluded feature representation, and
extract the feature representation related to the text data as an exclusion label when the feature representation does not correspond to the exclusion feature representation.

7. The information processing apparatus according to claim 1, wherein
the extraction unit is configured to
extract a feature representation related to the related text data selected by the second selection unit,
refer to a predetermined excluded feature representation, and
exclude the feature representation to be excluded from the text data when the feature representation to be excluded corresponds to the feature representation to be excluded.

8. The information processing apparatus according to claim 1, wherein
the display control unit is configured to
display the selected text data and the related text data by a first display method, wherein the first display method displays the topic by a different display method for each topic, or
extract only the feature representation from the text data and the related text data and display the feature representation by a second display method, wherein the second display method displays the feature representation labels with different appearances.

9. The information processing apparatus according to claim 8, wherein
the first display method and the second display method by the display control unit are switchable.

10. The information processing apparatus according to claim 8, wherein
the second display method includes displaying the acquired text data and the related text data in a tree shape.

11. The information processing apparatus according to claim 8, wherein
the display control unit is configured to
arrange the text data extracted by the extraction unit in order of appearance, and
display the feature representation and the feature representation label based on the appearance order.

12. The information processing apparatus according to claim 10, wherein
the display control unit is configured to
arrange the text data extracted by the extraction unit in order of appearance, and
display the feature representation and the feature representation label based on the appearance order.

13. The information processing apparatus according to claim 1, further comprising
a receiving unit configured to receive new text data,
a determination unit configured to determine a new description portion based on a difference between the new text data and the related text data,
a detection unit configured to detect the feature representation of the new description part, and
a recording unit configured to record the new text data and the new description portion.

14. The information processing apparatus according to claim 1, wherein
the feature representation label includes at least contents classified into "phenomenon", "countermeasure", and "result of countermeasure".

15. An information processing method executed by an information processing apparatus, comprising:
selecting at least one of the text data,
selecting related text data that is other text data related to the selected text data,
classifying the selected text data and the related text data into texts for respective topics,
extracting feature representations corresponding to a predetermined feature representation label from the selected text data and the related text data,
specifying the feature representation for each feature representation label,
displaying the feature representation on a display unit with an appearance different for each feature representation label, and
store the text data, the feature representation, and the feature representation label.

16. A non-transitory computer-readable storage medium storing a program that causes an information processing apparatus to execute,
selecting at least one of a plurality of pieces of text data,
selecting related text data that is other text data related to the selected text data,
classifying the selected text data and the related text data into texts for each topic,
extracting a feature representation corresponding to a predetermined feature representation label from the selected text data and the related text data,
specifying the feature representation for each of the feature representation labels,
displaying the feature representation on a display unit with an appearance different for each feature representation label, and
storing the text data, the feature representation, and the feature representation label.
